(19) United States
(12) Patent Application Publication
(10) Pub. No.: US 2024/0179186 A1
(43) Pub. Date: May 30, 2024

(54) PREDICTIVE LOAD BALANCING FOR A DIGITAL ENVIRONMENT

(71) Applicant: QOMPLX LLC, Reston, VA (US)

(72) Inventors: Jason Crabtree, Vienna, VA (US); Andrew Sellers, Monument, CO (US)

(21) Appl. No.: 18/434,779

(22) Filed: Feb. 6, 2024

Related U.S. Application Data
(63) Continuation of application No. 17/106,997, filed on Nov. 30, 2020.
Application No. 17/106,997 is a continuation-in-part of application No. 15/931,534, filed on May 13, 2020, now abandoned.

(51) Int. Cl. H04L 9/40; G06F 16/2458; G06F 16/951

(52) U.S. Cl. CPC H04L 63/20; G06F 16/2477; G06F 16/951; H04L 63/1425; H04L 63/1441

(57) ABSTRACT

A system and method for predictive load balancing for digital multiplayer gaming or simulated environments. The system includes an environment monitor subsystem that monitors a simulation or game condition and system load condition on a computational node of a networked computer environment over time, the game condition comprising a condition within a computer game operating on the computational node and across system nodes. The system also includes an automated planning service subsystem that performs a predictive analysis resulting in a system load forecast for the computational node and changes the system load on the computational node based on the system load forecast by changing a game control and adds or removes nodes, the game control comprising a limitation on the operation of the computer game operating on the computational node or the relationship between nodes or the number of nodes.

### CROSS-REFERENCE TO RELATED APPLICATIONS

Priority is claimed in the application data sheet to the following patents or patent applications, each of which is expressly incorporated herein by reference in its entirety:
Ser. No. 17/106,997
Ser. No. 15/931,534
Ser. No. 16/777,270
Ser. No. 16/720,383
Ser. No. 15/823,363
Ser. No. 15/725,274
Ser. No. 15/655,113
Ser. No. 15/237,625
Ser. No. 15/206,195
Ser. No. 15/186,453
Ser. No. 15/166,158
Ser. No. 15/141,752
Ser. No. 15/091,563
Ser. No. 14/986,536
Ser. No. 14/925,974
Ser. No. 15/683,765
Ser. No. 15/409,510
Ser. No. 15/379,899
Ser. No. 15/376,657
Ser. No. 16/718,906
Ser. No. 15/879,182
Ser. No. 15/850,037
Ser. No. 15/673,368
Ser. No. 15/489,716
Ser. No. 15/905,041
Ser. No. 16/191,054
Ser. No. 15/847,443
Ser. No. 15/790,457
Ser. No. 62/568,298
Ser. No. 15/790,327
Ser. No. 62/568,291
Ser. No. 16/654,309
Ser. No. 16/660,727
Ser. No. 15/229,476
Ser. No. 15/616,427

### BACKGROUND OF THE INVENTION

### Field of the Invention

The disclosure relates to the field server load balancing, particularly to load balancing of a server serving data for a digital environment.

### Discussion of the State of the Art

Massively multiplayer online (MMO) games first made their appearance in the mid-1990's. What started as a niche genre of games with few titles available has matured into dozens of games worldwide, and has gone on to become a huge staple to the gaming industry. However, the underlying technology has generally not made much progress. Many of the MMO games of today rely on separate servers to handle population loads. For instance, more popular MMO games may have a higher number of servers to accommodate the demand. Each server may be comprised of virtual nodes, each serving data for a particular section of a game environment. But simply providing more servers for players may not solve many of the problems that still persists today. These problems include long queue times to log into a server during peak gaming hours, server crashes caused by overwhelming demand, or slow response times due to lack of server resources. While some influxes of demand may be predictable, for example peak hours for a server, other influxes may not be so obvious, for example, an in-game event that is unexpectedly popular may cause outages due to the unpredicted congregation of players within a relatively small area. More advanced servers may provide a means to dynamically allocate server resources, but the allocation of resources may not occur until after a high load is already observed and some of the effects of server overburden have may already been experienced by the players. Furthermore, the scalability of such servers may be limited.

What is needed is a system that can dynamically deal with load influxes while providing a seamless experience to the players. Such a system would be able to predict load influxes, and dynamically allocate server resources before problems caused by server loading occurs. Also, such a system would be capable of mass scalability, potentially scaling to millions of players.

### SUMMARY OF THE INVENTION

Accordingly, the inventor has conceived a system for predictive load balancing for a digital environment. In a typical embodiment, the system continuously monitors and evaluates current load data, and analyzed against historical data pertaining to node load. The evaluation includes predictive analysis to allow the system to forecast load influxes, and preemptively enact load balancing measures before the effects of server overburden is encountered by the players to allow an uninterrupted, and overall smooth experience.

In one aspect of the invention, a system for predictive load balancing for a digital environment is provided comprising a time series data retrieval and storage server comprising a memory, a processor, and a plurality of programming instructions stored in the memory thereof and operable on the processor thereof, wherein the programmable instructions, when operating on the processor, cause the processor to monitor and record load-related data of a computational node; and an automated planning service module comprising a memory, a processor, and a plurality of programming instructions stored in the memory thereof and operable on the processor thereof, wherein the programmable instructions, when operating on the processor, cause the processor to retrieve node load-related data from the time series data retrieval and storage server, perform predictive analysis using the node load-related data, and determine whether load balancing is required. In another aspect, additional nodes are automatically added and integrated when load balancing has been determined to be required. In another aspect, resources from other nodes are reallocated to at least a busy node when load balancing has been determined to be required. In another aspect, a connector module is included, wherein a node may utilize the connector module to communicate and exchange data with other nodes to facilitate load balancing. In another aspect, at least a portion of the load-related data used for predictive analysis is user contribution to system load. In another aspect, at least a portion of the load-related data used for predictive analysis is game-related environmental contribution to system load. In another aspect, at least a portion of the load-related data used for predictive analysis are scheduled events.

In another aspect of the invention, a method for predictive load balancing for a digital environment is provided, comprising the steps of (a) monitoring and recording load-related data of a computational node with a time series data retrieval and storage server; (b) retrieving node load-related data from the time series data retrieval and storage server with an automated planning service module; (c) performing predictive analysis using the node load-related data with the automated planning service module; and (d) determining whether load balancing is required with an automated planning service module.

### BRIEF DESCRIPTION OF THE DRAWING FIGURES

The accompanying drawings illustrate several aspects and, together with the description, serve to explain the principles of the invention according to the aspects. It will be appreciated by one skilled in the art that the particular arrangements illustrated in the drawings are merely exemplary, and are not to be considered as limiting of the scope of the invention or the claims herein in any way.

FIG. 1 is a diagram of an exemplary architecture of a business operating system according to an embodiment of the invention.

FIG. 2A is a diagram of a multidimensional time series data module as shown in FIG. 1 further configured for use in various embodiments of the invention.

FIG. 2B is a diagram of an automated planning service module as shown in FIG. 1 further configured for use in various embodiments of the invention.

FIG. 2C is a diagram of a connector module as shown in FIG. 1 further configured for use in various embodiments of the invention.

FIG. 3 is a diagram of the web application-based interface for an indexed global tile module as per one embodiment of the invention.

FIG. 4 is a diagram of an indexed global tile module as per one embodiment of the invention.

FIG. 5 is a flow diagram illustrating the function of the indexed global tile module as per one embodiment of the invention.

FIG. 6A is a block diagram of an exemplary node as used in various embodiments of the invention.

FIG. 6B is an illustration of a segment of an exemplary system of nodes as used in various embodiments of the invention.

FIG. 7 is a flow diagram illustrating a method for gathering data for use in forecasting future loads according to various embodiments of the invention.

FIG. 8 is a flow diagram illustrating a method for predictive load balancing according to various embodiments of the invention.

FIG. 9 is a block diagram illustrating an exemplary hardware architecture of a computing device used in various embodiments of the invention.

FIG. 10 is a block diagram illustrating an exemplary logical architecture for a client device, according to various embodiments of the invention.

FIG. 11 is a block diagram illustrating an exemplary architectural arrangement of clients, servers, and external services, according to various embodiments of the invention.

FIG. 12 is another block diagram illustrating an exemplary hardware architecture of a computing device used in various embodiments of the invention.

### DETAILED DESCRIPTION OF THE INVENTION

The inventor has conceived, and reduced to practice, a system for predictive load balancing for a digital environment.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Conceptual Architecture

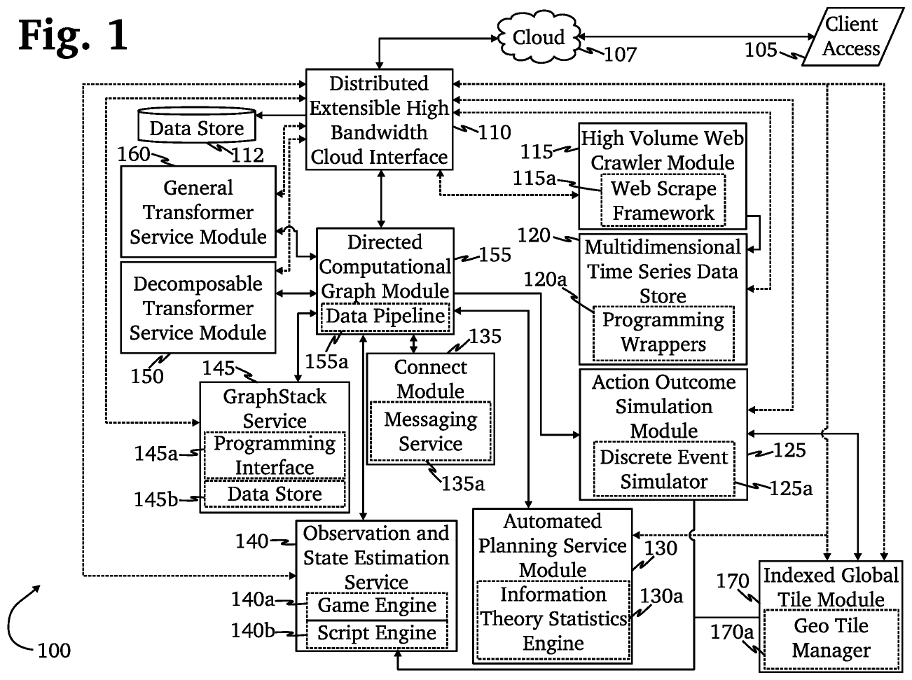

FIG. 1 is a diagram of an exemplary architecture of a business operating system 100 according to an embodiment of the invention. Client access to system 105 for specific data entry, system control and for interaction with system output such as automated predictive decision making and planning and alternate pathway simulations, occurs through the system's distributed, extensible high bandwidth cloud interface 110 which uses a versatile, robust web application driven interface for both input and display of client-facing information and a data store 112 such as, but not limited to MONGODB™, COUCHDB™, CASSANDRA™ or REDIS™ depending on the embodiment. Much of the business data analyzed by the system both from sources within the confines of the client business, and from cloud based sources 107, public or proprietary such as, but not limited to: subscribed business field specific data services, external remote sensors, subscribed satellite image and data feeds and web sites of interest to business operations both general and field specific, also enter the system through the cloud interface 110, data being passed to the connector module 135 which may possess the API routines 135a needed to accept and convert the external data and then pass the normalized information to other analysis and transformation components of the system, the directed computational graph module 155, high volume web crawler module 115, multidimensional time series database 120 and a graph stack service 145. Directed computational graph module 155 retrieves one or more streams of data from a plurality of sources, which includes, but is not limited to, a plurality of physical sensors, network service providers, web based questionnaires and surveys, monitoring of electronic infrastructure, crowd sourcing campaigns, and human input device information. Within directed computational graph module 155, data may be split into two identical streams in a specialized pre-programmed data pipeline 155a, wherein one sub-stream may be sent for batch processing and storage while the other sub-stream may be reformatted for transformation pipeline analysis. The data may be then transferred to a general transformer service module 160 for linear data transformation as part of analysis or the decomposable transformer service module 150 for branching or iterative transformations that are part of analysis. Directed computational graph module 155 represents all data as directed graphs where the transformations are nodes and the result messages between transformations edges of the graph. High-volume web crawling module 115 may use multiple server hosted preprogrammed web spiders which, while autonomously configured, may be deployed within a web scraping framework 115a of which SCRAPY™ is an example, to identify and retrieve data of interest from web based sources that are not well tagged by conventional web crawling technology. Multiple dimension time series data store module 120 may receive streaming data from a large plurality of sensors that may be of several different types. Multiple dimension time series data store module 120 may also store any time series data encountered by system 100 such as, but not limited to, environmental factors at insured client infrastructure sites, component sensor readings and system logs of some or all insured client equipment, weather and catastrophic event reports for regions an insured client occupies, political communiques and/or news from regions hosting insured client infrastructure and network service information captures (such as, but not limited to, news, capital funding opportunities and financial feeds, and sales, market condition), and service related customer data. Multiple dimension time series data store module 120 may accommodate irregular and high-volume surges by dynamically allotting network bandwidth and server processing channels to process the incoming data. Inclusion of programming wrappers 120a for languages—examples of which may include, but are not limited to, C++, PERL, PYTHON, and ERLANG™—allows sophisticated programming logic to be added to default functions of multidimensional time series database 120 without intimate knowledge of the core programming, greatly extending breadth of function. Data retrieved by multidimensional time series database 120 and high-volume web crawling module 115 may be further analyzed and transformed into task-optimized results by directed computational graph 155 and associated general transformer service 160 and decomposable transformer service 150 modules. Alternately, data from the multidimensional time series database and high-volume web crawling modules may be sent, often with scripted cuing information determining important vertices 145a, to graph stack service module 145 which, employing standardized protocols for converting streams of information into graph representations of that data, for example open graph internet technology (although the invention is not reliant on any one standard). Through the steps, graph stack service module 145 represents data in graphical form influenced by any pre-determined scripted modifications 145a and stores it in a graph-based data store 145b such as GIRAPH™ or a key-value pair type data store REDIS™, or RIAK™, among others, any of which are suitable for storing graph-based information.

Results of the transformative analysis process may then be combined with further client directives, additional business rules and practices relevant to the analysis and situational information external to the data already available in automated planning service module 130, which also runs powerful information theory-based predictive statistics functions and machine learning algorithms 130a to allow future trends and outcomes to be rapidly forecast based upon the current system derived results and choosing each a plurality of possible business decisions. Then, using all or most available data, automated planning service module 130 may propose business decisions most likely to result in favorable business outcomes with a usably high level of certainty. Closely related to the automated planning service module 130 in the use of system-derived results in conjunction with possible externally supplied additional information in the assistance of end user business decision making, action outcome simulation module 125 with a discrete event simulator programming module 125a coupled with an end user-facing observation and state estimation service 140, which is highly scriptable 140b as circumstances require and has a game engine 140a to more realistically stage possible outcomes of business decisions under consideration, allows business decision makers to investigate the probable outcomes of choosing one pending course of action over another based upon analysis of the current available data.

A significant proportion of the data that is retrieved and transformed by the business operating system, both in real world analyses and as predictive simulations that build upon intelligent extrapolations of real world data, may include a geospatial component. The indexed global tile module 170 and its associated geo tile manager 170a may manage externally available, standardized geospatial tiles and may enable other components of the business operating system, through programming methods, to access and manipulate meta-information associated with geospatial tiles and stored by the system. The business operating system may manipulate this component over the time frame of an analysis and potentially beyond such that, in addition to other discriminators, the data is also tagged, or indexed, with their coordinates of origin on the globe. This may allow the system to better integrate and store analysis specific information with all available information within the same geographical region. Such ability makes possible not only another layer of transformative capability, but may greatly augment presentation of data by anchoring to geographic images including satellite imagery and superimposed maps both during presentation of real world data and simulation runs.

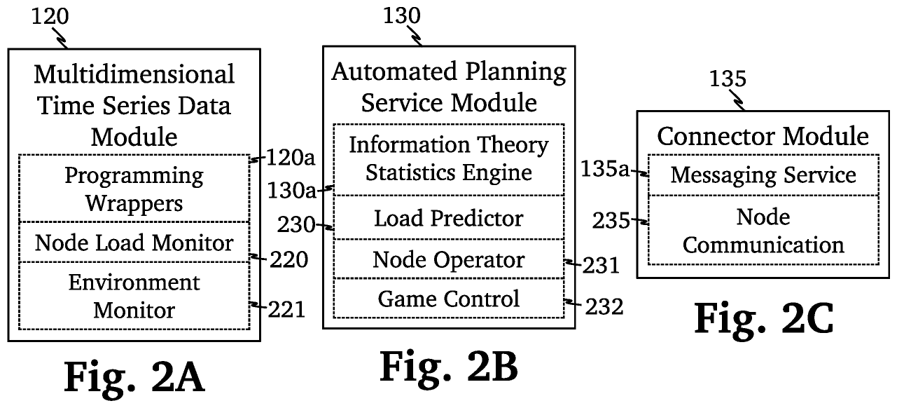

FIG. 2A is a diagram of a multidimensional time series data module 120 as shown in FIG. 1 further configured for use in various embodiments of the invention. Besides the programming wrapper 120a mentioned above, multidimensional time series data module 120 may include a node load monitor 220, and an environment monitor 221. Node load monitor 220 may continuously gather information on a particular node such as, without limitation, current player count on the present node, overall resources currently in use in the present node, and how various objects and actions are affecting the load on the present node. The information gathered by monitor 220 may be stored in memory for use in load prediction by other functions of business operating system 100.

Environment monitor 221 may monitor the present environmental conditions within a node or system. This may include, for example, large-scale battles between alliances, in-game weather conditions, or some type of epidemic that may affect players. The data may be preserved as a snapshot at a specific time, and exported. The exported data may then be used as seed data for independent simulations.

FIG. 2B is a diagram of an automated planning service module 130 as shown in FIG. 1 further configured for use in various embodiments of the invention. Besides the information theory statistics engine 130a, automated planning service module 130 may also be configured to include functions for a load predictor 230, a node operator 231, and a game control function 232. Load predictor 230 may use node load data as it is being gathered, or data that was previously gathered and stored by monitor 220.

Node operator 231 may act on results generated by load predictor 230 to allocate resources, for example, by dynamically starting up and integrating a new node to accommodate a forecasted load influx, or shutting down a node as demand diminishes.

Game control 232 may be used by administrators of a game to seamlessly implement and propagate new rules or limitations within the game without interruption or downtime. Things that may be implemented include, but not limited by, change in environmental conditions, adding or removing questlines, or implementing incentives to influence the course of gameplay. Game control 232 may also implement rules without input from system administrators. For example, if system rules determine that a slight difficulty shift is needed, game control 232 may autonomously implement needed changes.

FIG. 2C is a diagram of a connector module as shown in FIG. 1 further configured for use in various embodiments of the invention. Besides messaging service 135a, connector module 135 may include a node communication module 235. Node communication module 235 may provide functions for communication and exchanging of information between nodes, either within a system or outside of a system.

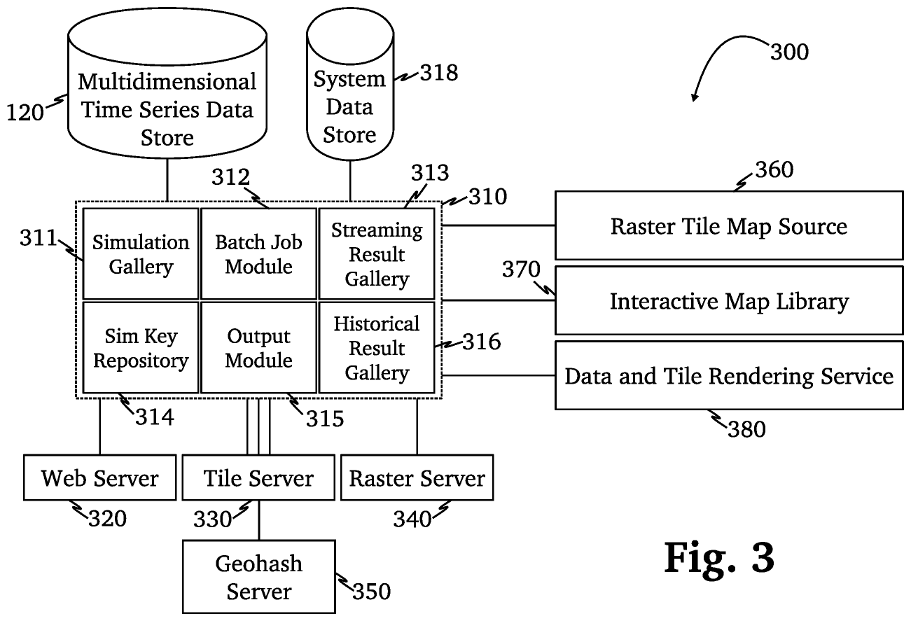

FIG. 3 is a diagram of the web application based interface 300 for an indexed global tile module as per one embodiment of the invention. User interaction with indexed global tile module 170 may be mediated through a web-based interface 310. Web interface 310 may retrieve at least a portion of geospatial data not previously referenced from a plurality of remote, possibly cloud-based sources which include but are not limited to raster tile map sources 360, interactive map libraries 370 and data and tile rendering services 380 which may resolve business decision data onto a geographical location or region. Other services known to those skilled in the field may exist and be used as needed. Direct interaction between the function of business operating system 100 and the capabilities of indexed global tile module 170 may pertain to both real world analyses and simulations run by the system. The web application therefore keeps galleries for simulations 311, streaming analyses results 313 and historical analyses results 316 which may allow app users to retrieve these records from system data stores which may include multidimensional time series data store 120 for analyses involving series of repeated sensor readings or repeated updates of highly similar data, or other similar data series of short to moderate amounts of information; and other system associated data stores 318 for analyses of more extensive freeform text or similar data records. Once a simulation or real-world analysis is chosen, users may add simple geospatial information to them such as a unique geo-hash, calculated within geo-hash server 350 that is closely based upon the geographical coordinates where the data originated that then allows the simulation or real-world analysis to be correlated with other analyses within a pre-determined location radius based upon those geo-hashes which have increasing similarity based upon increased proximity. Addition of complex geospatial information, such as detailed indexed time-corrected geospatial tile images; or fully user annotated, labelled time-corrected geospatial tile series with map overlays for the length of the analysis, depending on the requirements of the study being carried out. To allow modification of running simulations, the web app may be capable of supplying the key for the correct, desired simulation and therefore keeps a repository of those keys 314. A plurality of jobs run by the indexed global tile module require both a large amount of resources and time to complete and may therefore be run as batch jobs by a batch job module 312. All output from the manipulation done by the web application may be mediated by an output module 315. The web application may be hosted on a web server 320. Indexed geospatial tiles are retrieved from at least one tile server 330 which may be local or cloud based. Geo-hashes may be calculated from specific tiles of interest by a geohash server 350. Tiles and map overlays may be rasterized for output by a raster server 340.

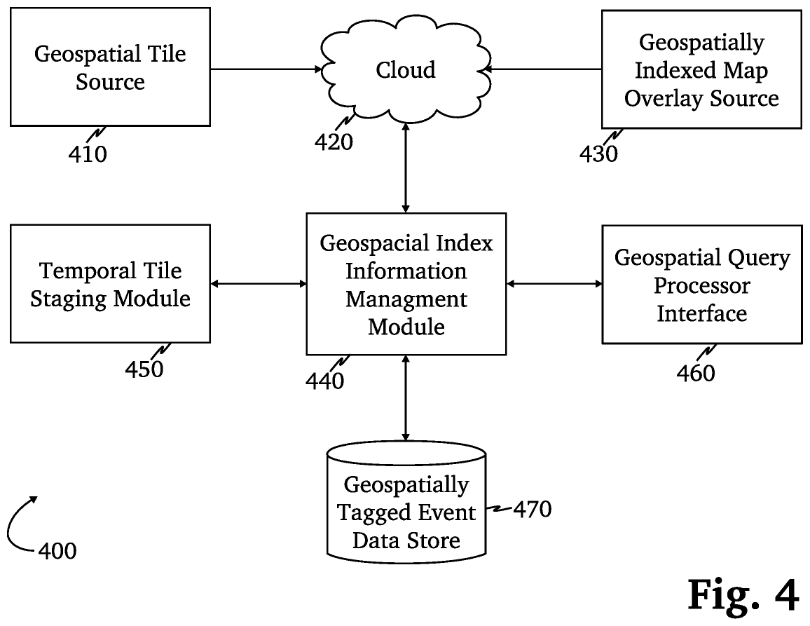

FIG. 4 is a diagram of an indexed global tile module 400 as per one embodiment of the invention. A significant amount of the data transformed and simulated by the business operating system has an important geospatial component. Indexed global tile module 170 allows both for the geo-tagging storage of data as retrieved by the system as a whole and for the manipulation and display of data using its geological data to augment the data's usefulness in transformation, for example creating ties between two independently acquired data points to more fully explain a phenomenon; or in the display of real world, or simulated results in their correct geospatial context for greatly increased visual comprehension and memorability. Indexed global tile module 170 may consist of a geospatial index information management module which retrieves indexed geospatial tiles from a cloud-based source 410, 420 known to those skilled in the art, and may also retrieve available geospatially indexed map overlays from a geospatially indexed map overlay source 430 known to those skilled in the art. Tiles and their overlays, once retrieved, represent large amounts of potentially reusable data and are therefore stored for a pre-determined amount of time to allow rapid recall during one or more analyses on a temporal staging module 450. To be useful, it may be required that both the transformative modules of the business operating system, such as, but not limited to directed computational graph module 155, automated planning service module 130, action outcome simulation module 125, and observational and state estimation service 140 be capable of both accessing and manipulating the retrieved tiles and overlays. A geospatial query processor interface 460 serves as a program interface between these system modules and geospatial index information management module 440 which fulfills the resource requests through specialized direct tile manipulation protocols, which for simplistic example may include “get tile xxx,” “zoom,” “rotate,” “crop,” “shape,” “stitch,” and “highlight” just to name a very few options known to those skilled in the field. During analysis, the geospatial index information management module may control the assignment of geospatial data and the running transforming functions to one or more swimlanes to expedite timely completion and correct storage of the resultant data with associated geotags. The transformed tiles with all associated transformation tagging may be stored in a geospatially tagged event data store 470 for future review. Alternatively, just the geotagged transformation data or geotagged tile views may be stored for future retrieval of the actual tile and review depending on the need and circumstance. There may also be occasions where time series data from specific geographical locations are stored in multidimensional time series data store 120 with geo-tags provided by geospatial index information management module 440.

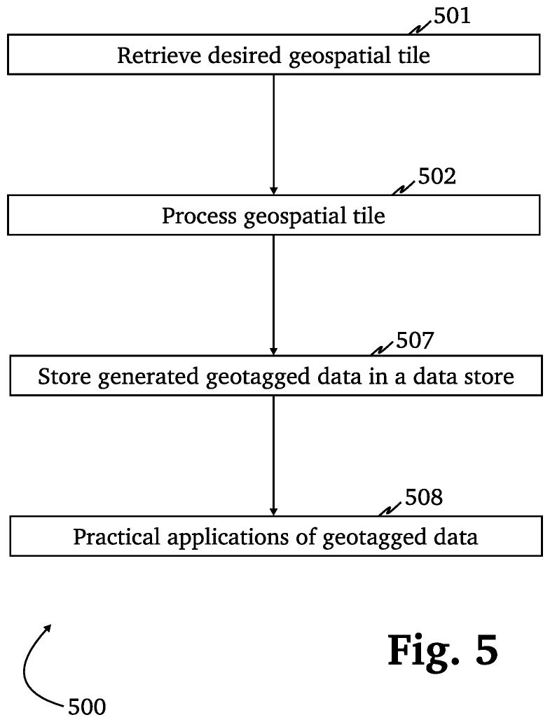

FIG. 5 is a flow diagram illustrating the function 500 of the indexed global tile module as per one embodiment of the invention. Predesignated, indexed geospatial tiles are retrieved from sources known to those skilled in the art at step 501. Available map overlay data, retrieved from one of multiple sources known to those skilled in the art may be optionally retrieved per user design. The geospatial tiles may then be processed in one or more of a plurality of ways according to the design of the running analysis at step 502, at which time geo-tagged event or sensor data may be associated with the indexed tile which may be directed programmatically or as a result of user interaction through web application 310. Geo-tagging, either interactive or programmatic, may be applied to data at or near real time, applied to transformed data that has been previously archived to augment those data alone for direct presentation or further self-contained analysis, applied to augment the data so as to allow their inclusion in subsequent predictive analyses on the basis of their geographical location of occurrence in larger location based or regionally based analyses with either other archival or real-time data. Data relating to tile processing, which may include the tile itself is then stored for later review or analysis at step 507. At step 508, the geotagged may be utilized for practical applications, for instance, the data, in part, or in its entirety may be used in one or more transformations that are part of a real-world data presentation, part of in its entirety may be used in one or more transformations that are part of a simulation, and at least some of the geospatial data may be used in an analyst-determined direct visual presentation or may be formatted and transmitted for use in third party solutions.

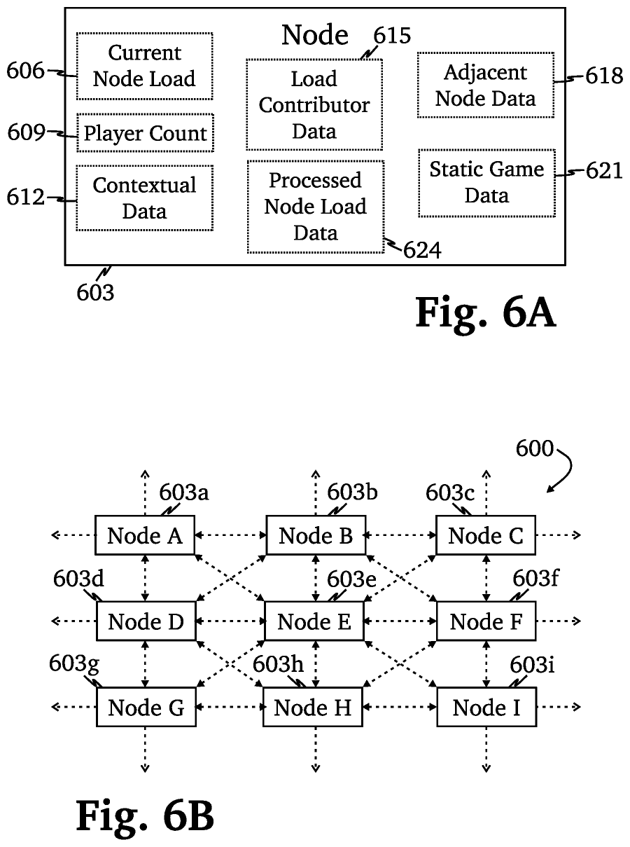

Besides providing a means for the applications described above, global tile module 170 may also be used to serve data for a virtual environment, such as a virtual environment for a video game. Developers may create a virtual environment and implement the world to business operating system 100 and utilize global tile module 170. The ability to easily add or remove geospatial tiles using global tile module 170 provides an ideal way for developers to scale their worlds to accommodate to their needs and requirements. Furthermore, for applications such as a massively multiplayer game, cach geospatial tile may be configured to be its own node, which is described below in FIG. 6A, and players within this online virtual world may move seamlessly from one tile to another. Each node may be configured to seamlessly split into a plurality of smaller nodes to provide a means for load balancing if a node should become overburdened. Additional nodes may also be implemented on a more permanent basis to provide easy scalability through the features of global tile module 170, for example, if a developer wishes to add more areas to the virtual environment or a more permanent node capacity increase is required.

FIG. 6A is a block diagram of an exemplary node 603 as used in various embodiments of the invention. Node 603 may be a physical system, a virtual node, or any other type of server commonly used in the art. The information stored within a node may include, but is not limited to, current node load 606, player count 609, contextual data 612, load contributor data 615, adjacent node data 618, static game data 621, and processed node load data 624. Contextual data 612 may be information pertaining to the context of game's world including, but not limited to, ongoing in-game events, in-game alliances and rivalries, and progression of overarching storylines.

Load contributor data 615 may be information pertaining to a certain player or group of players, game events, or other environment factors (e.g., location and interaction between and among users) and their effects and contributions to overall node load. This data may be used in conjunction with other data by load predictor 230 to more accurately forecast load influxes by taking into consideration the load contributed by highly variable factors.

Adjacent node data 618 may be data and statistics provided by adjacent nodes. This information may aid in the allocation of resources by allowing a particular node to be more spatially aware of what is occurring around it within the surrounding nodes. For example, if a large-scale battle as part of an in-game event is moving locations, adjacent nodes may be alerted to the movement. Load balancing measures may be preemptively enacted on the next node to provide a smooth experience for incoming players. According to an implementation, the system may be configured to minimize cross-node traffic with respect to network loads.

Processed node load data 624 may be historic node load data that has been processed by business operating system 100 for use in node load prediction. This data may be data gathered system-wide, or node-specific.

FIG. 6B is an illustration of a segment 600 of an exemplary system of nodes as used in various embodiments of the invention. Segment 600 comprises a plurality of nodes 603a to 603i. Adjacent nodes are connected as indicated by dashed arrows. It should be understood that the shape and layout of the nodes in segment 600 are not indicative of the only layout possible of the invention. Layouts may vary, and nodes may take any practical shape or form. Adjacent nodes may not always be next to one another in some systems. Additionally, the illustrated number of nodes does not indicate any limitation of the present invention, and the specific number was chosen for simplicity of demonstration. With the mass-scalability of business operating system 100, a system of nodes may potentially comprise an unlimited number of nodes of various shapes and sizes where physical resource may be the only limit, potentially capable of dealing with millions, if not billions, of players at a time.

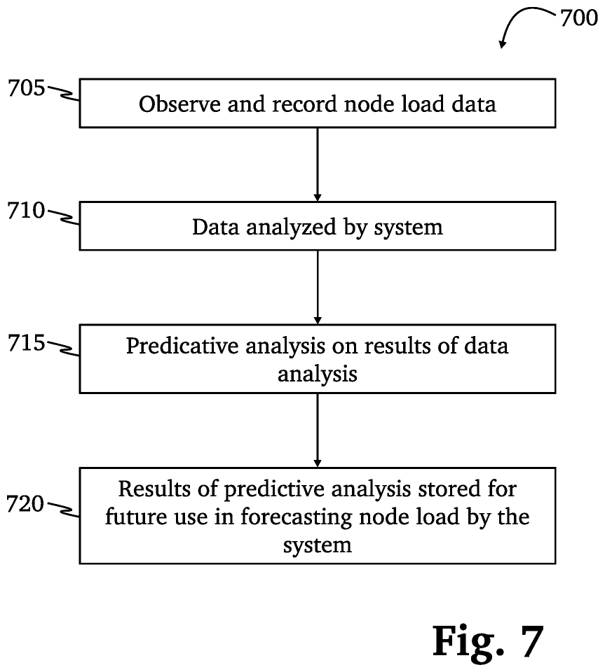

FIG. 7 is a flow diagram illustrating a method 700 for gathering data for use in forecasting future loads according to various embodiments of the invention. At step 705, node load data is observed and recorded by the system. Node load data may include, but is not limited to, current node load, player count, and load contributor data, all of which are described in greater detail in FIG. 6A. At step 710, the data may be processed, and cleansed for analysis by business operating system 100.

At step 715, predictive analysis is done on the data previously analyzed in step 710 by business operating system 100 with automated planning service module 130. At step 720, results of the predictive analysis are stored by business operating system as reference data in forecasting node load by business operating system 100.

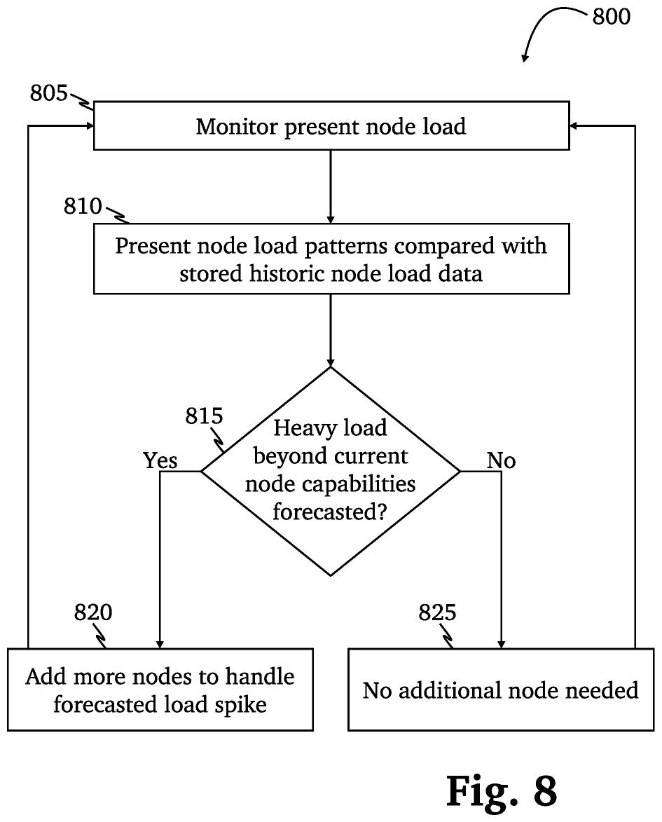

FIG. 8 is a flow diagram illustrating a method 800 for predictive load balancing according to various embodiments of the invention. At step 805, node load is monitored by the node load monitor. At step 810, present node load patterns are evaluated against previously processed node load data using predictive algorithms of business operating system 100. Some of the factors include, but not limited to, current player count, current game events, appearance of unusual contributors to overall node load, adjacent node loads, and the like. At step 815, if a load spike that is beyond the current load-handling capabilities of a node, the flowchart goes to step 820. At step 820, more resources are allocated, and the load may be balanced to provide a smoother experience. This may be accomplished by either redistributing resources from adjacent nodes, or through the addition of more nodes. On the other hand, if a load influx is not forecasted, the flowchart goes to step 825. At step 825, the system proceeds as usual without resource reallocation.

After steps 820 or 825, the process returns to step 805 and method 800 may be repeated. Method 800 may repeat as a background process, and may run as many times as is required while the system is active.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines, or other appropriate virtual environments).

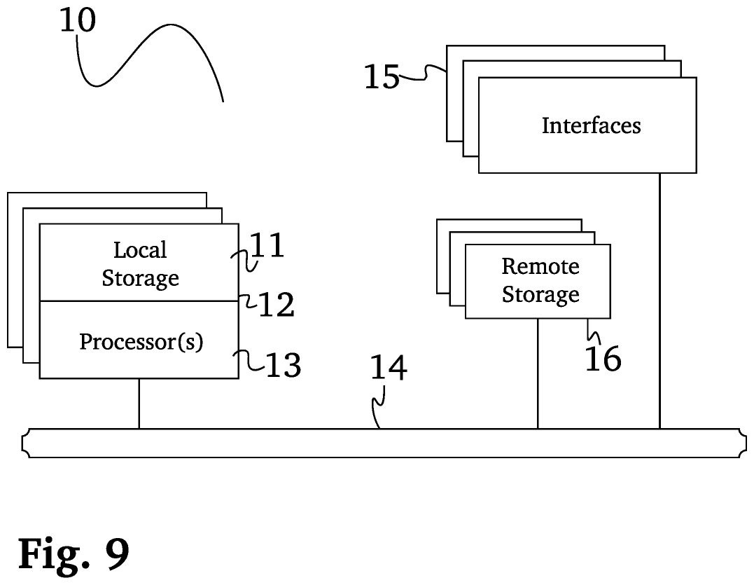

Referring now to FIG. 9, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some aspects, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 9 illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the aspects described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device aspects may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

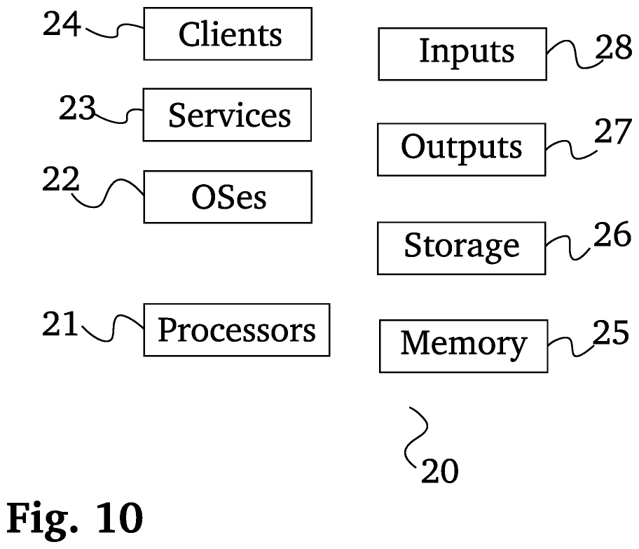

In some aspects, systems may be implemented on a standalone computing system. Referring now to FIG. 10, there is shown a block diagram depicting a typical exemplary architecture of one or more aspects or components thereof on a standalone computing system. Computing device 20 includes processors 21 that may run software that carry out one or more functions or applications of aspects, such as for example a client application 24. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 9). Examples of storage devices 26 include flash memory, magnetic hard drive, CD-ROM, and/or the like.

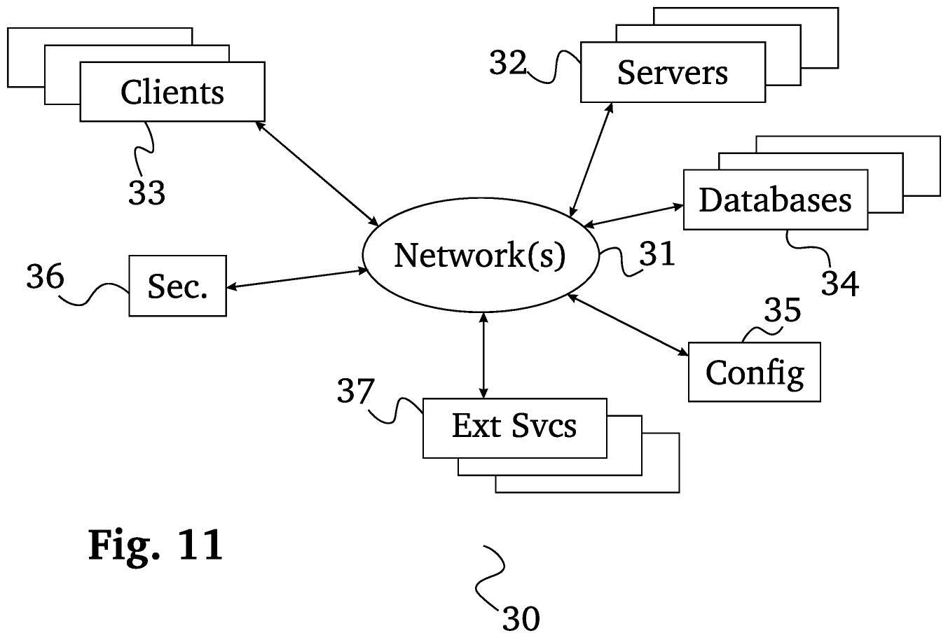

In some aspects, systems may be implemented on a distributed computing network, such as one having any number of clients and/or servers. Referring now to FIG. 11, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 10. In addition, any number of servers 32 may be provided for handling requests received from one or more clients 33. Clients 33 and servers 32 may communicate with one another via one or more electronic networks 31, which may be in various aspects any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some aspects, servers 32 may call external services 37 when needed to obtain additional information, or to refer to additional data concerning a particular call. Communications with external services 37 may take place, for example, via one or more networks 31. In various aspects, external services 37 may comprise web-enabled services or functionality related to or installed on the hardware device itself. For example, in one aspect where client applications 24 are implemented on a smartphone or other electronic device, client applications 24 may obtain information stored in a server system 32 in the cloud or on an external service 37 deployed on one or more of a particular enterprise's or user's premises.

In some aspects, clients 33 or servers 32 (or both) may make use of one or more specialized services or appliances that may be deployed locally or remotely across one or more networks 31. For example, one or more databases 34 may be used or referred to by one or more aspects. It should be understood by one having ordinary skill in the art that databases 34 may be arranged in a wide variety of architectures and using a wide variety of data access and manipulation means. For example, in various aspects one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some aspects, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some aspects may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with aspects without limitation, unless a specific security 36 or configuration system 35 or approach is specifically required by the description of any specific aspect.

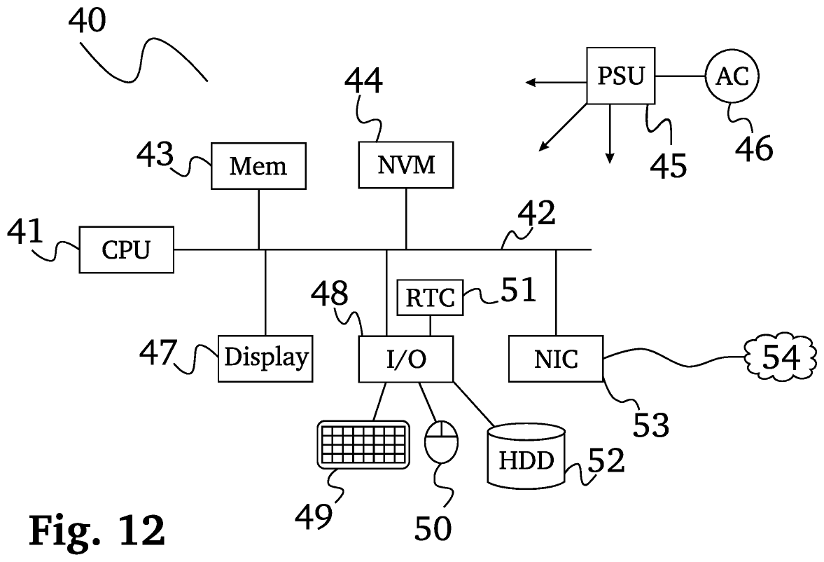

FIG. 12 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various aspects, functionality for implementing systems or methods of various aspects may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various aspects described above. Accordingly, the present invention is defined by the claims and their equivalents.

What is claimed is:

1. A computing system for predictive load balancing for a networked computer gaming environment employing an automated planning service, the computing system comprising:
one or more hardware processors configured for:
monitoring a game condition and a system load condition on a computational node of a networked computer gaming environment over time, the game condition comprising a condition within a computer game operating on the computational node;
storing time series data on a non-volatile data storage device, the time series data comprising changes of the game condition and the system load condition at a series of time points;
performing a predictive analysis based on the time series data to generate a system load forecast for the computational node; and
changing the system load on the computational node based on the system load forecast by changing a game control, the game control comprising a limitation on the operation of the computer game operating on the computational node.

2. The computing system of claim 1, wherein the load on the computational node is changed by adding or removing computational nodes.

3. The computing system of claim 1, wherein the load on the computational node is changed by reallocating computing resources from other nodes to the computational node.

4. The computing system of claim 1 further comprising a connector subsystem, wherein a node may utilize the connector subsystem to communicate and exchange data with other nodes to facilitate load balancing.

5. The computing system of claim 1, wherein at least a portion of the load-related data used for predictive analysis is user contribution to system load.

6. The computing system of claim 1, wherein the time-series data further comprise scheduled events.

7. The computing system of claim 1, wherein the predictive analysis is performed using model-based forecasts or simulations based on the time series data.

8. The computing system of claim 1, wherein the game condition further comprises state information about a user agent, a game agent, or another entity.

9. The computing system of claim 1, wherein the game condition further comprises player activity data, the player activity data comprising login information, actions, and location data.

10. The computing system of claim 1, wherein the load on the computational node is changed by adjusting the relationship between the computational node and at least one other node.

11. A computer-implemented method executed on an automated planning service for predictive load balancing for a networked computer gaming environment, the computer-implemented method comprising:
monitoring a game condition and a system load condition on a computational node of a networked computer gaming environment over time, the game condition comprising a condition within a computer game operating on the computational node;
storing time series data on a non-volatile data storage device, the time series data comprising changes of the game condition and the system load condition at a series of time points;
performing predictive analysis based on the time series data to generate a system load forecast for the computational node; and
changing the system load on the computational node based on the system load forecast by changing a game control, the game control comprising a limitation on the operation of the computer game operating on the computational node.

12. The computer-implemented method of claim 11, further comprising the step of changing the system load on the computational node by adding computational nodes.

13. The computer-implemented method of claim 11, further comprising the step of changing the system load on the computational node by reallocating computing resources from other nodes to the computational node.

14. The computer-implemented method of claim 11, further comprising a connector subsystem, wherein a node may utilize the connector subsystem to communicate and exchange data with other nodes to facilitate load balancing.

15. The computer-implemented method of claim 11, wherein the time-series data further comprise user contribution to the load.

16. The computer-implemented method of claim 11, wherein the time-series data further comprise scheduled events.

17. The computer-implemented method of claim 11, wherein the predictive analysis is performed using simulations based on the time series data.

18. The computer-implemented method of claim 11, wherein the game condition further comprises state information about a user agent, a game agent, or another entity.

19. The computer-implemented method of claim 11, wherein the game condition further comprises player activity data, the player activity data comprising login information, actions, and location data.

20. The computer-implemented method of claim 11, wherein the load on the computational node is changed by adjusting the relationship between the computational node and at least one other node.

21. A system for predictive load balancing for a networked computer gaming environment employing an automated planning service, comprising one or more computers with executable instructions that, when execute, cause the system to:
monitor a game condition and a system load condition on a computational node of a networked computer gaming environment over time, the game condition comprising a condition within a computer game operating on the computational node;
store time series data on a non-volatile data storage device, the time series data comprising changes of the game condition and the system load condition at a series of time points;
perform a predictive analysis based on the time series data to generate a system load forecast for the computational node; and
change the system load on the computational node based on the system load forecast by changing a game control, the game control comprising a limitation on the operation of the computer game operating on the computational node.

22. The system of claim 21, wherein the load on the computational node is changed by adding computational nodes.

23. The system of claim 21, wherein the load on the computational node is changed by reallocating computing resources from other nodes to the computational node.

24. The system of claim 21 further comprising a connector subsystem, wherein a node may utilize the connector subsystem to communicate and exchange data with other nodes to facilitate load balancing.

25. The system of claim 21, wherein at least a portion of the load-related data used for predictive analysis is user contribution to system load.

26. The system of claim 21, wherein the time-series data further comprise scheduled events.

27. The system of claim 21, wherein the predictive analysis is performed using model-based forecasts or simulations based on the time series data.

28. The system of claim 21, wherein the game condition comprises state information about a user agent, a game agent, or another entity.

29. The system of claim 21, wherein the game condition further comprises player activity data, the player activity data comprising login information, actions, and location data.

30. The system of claim 21, wherein the load on the computational node is changed by adjusting the relationship between the computational node and at least one other node.

31. Non-transitory, computer-readable storage media having computer-executable instructions embodied thereon that, when execute by one or more processors of a computing system employing an automated planning service for predictive load balancing for a networked computer gaming environment, cause the computing system to:
monitor a game condition and a system load condition on a computational node of a networked computer gaming environment over time, the game condition comprising a condition within a computer game operating on the computational node;
store time series data on a non-volatile data storage device, the time series data comprising changes of the game condition and the system load condition at a series of time points;
perform a predictive analysis based on the time series data to generate a system load forecast for the computational node; and
change the system load on the computational node based on the system load forecast by changing a game control, the game control comprising a limitation on the operation of the computer game operating on the computational node.

32. The system of claim 31, wherein the load on the computational node is changed by adding computational nodes.

33. The system of claim 31, wherein the load on the computational node is changed by reallocating computing resources from other nodes to the computational node.

34. The system of claim 31 further comprising a connector subsystem, wherein a node may utilize the connector subsystem to communicate and exchange data with other nodes to facilitate load balancing.

35. The system of claim 31, wherein at least a portion of the load-related data used for predictive analysis is user contribution to system load.

36. The system of claim 31, wherein the time-series data further comprise scheduled events.

37. The system of claim 31, wherein the predictive analysis is performed using model-based forecasts or simulations based on the time series data.

38. The system of claim 31, wherein the game condition comprises state information about a user agent, a game agent, or another entity.

39. The system of claim 31, wherein the game condition further comprises player activity data, the player activity data comprising login information, actions, and location data.

40. The system of claim 31, wherein the load on the computational node is changed by adjusting the relationship between the computational node and at least one other node.
